(19) United States
(12) Patent Application Publication
(10) Pub. No.: US 2016/0300535 A1
(43) Pub. Date: Oct. 13, 2016

(54) LASER DIODE DRIVEN LCD QUANTUM DOT HYBRID DISPLAYS

(71) Applicant: DOLBY LABORATORIES LICENSING CORPORATION, San Franscisco, CA (US)

(72) Inventors: John GILBERT, Pacifica, CA (US); Scott P. ROBINSON, Sausalito, CA (US); Kenneth SCHINDLER, Alameda, CA (US); Martin J. RICHARDS, Redwood City, CA (US)

(73) Assignee: DOLBY LABORATORIES LICENSING CORPORATION, San Francisco, CA (US)

(21) Appl. No.: 15/100,820

(22) PCT Filed: Dec. 5, 2014
(86) PCT No.: PCT/US2014/068757

§ 371 Date: Jun. 1, 2016

Related U.S. Application Data
(60) Provisional application No. 61/914,055, filed on Dec. 10, 2013.

(51) Int. Cl. G09G 3/34; G09G 3/36; G02F 1/1335; G09G 3/20

(52) U.S. Cl. CPC G09G 3/342; G09G 3/2003; G09G 3/36; G02F 1/133504; G02F 1/133514; G02F 1/133528; G02F 1/133555; G02F 1/133617; G02F 1/133526; G09G 2300/0452; G09G 2320/0233; G09G 2320/0646; G09G 2300/023; G02F 2001/133614; G02F 2202/36

(57) ABSTRACT

A display system comprising a set of light sources that emit a set of frequencies that are capable of exciting a set of quantum dots is disclosed. The display system further comprises a controller that receives input image data to be rendered by the display system and sends out control signals to various components. In one embodiment, the display system may further comprise one, two or more modulators that illuminate the set of quantum dots to form a final rendered image. In one embodiment, the set of light sources optionally comprise a light of substantially uniform polarization—e.g., laser light sources—and may be modulated according to control signal from said controller. Other optional components may comprise a starting polarizer, a mid-polarizer, a first laser light filter, a finishing polarizer and a final laser light filter/reflector.

### CROSS-REFERENCE TO RELATED APPLICATION

This application claims priority from U.S. Provisional patent Application No. 61/914,055 filed 10 Dec. 2013, which is hereby incorporated by reference in its entirety.

### BACKGROUND OF THE INVENTION

1. Field of Invention

The present invention relates to display systems, and more particularly, to High Dynamic Range (HDR) display systems.

2. Discussion of Background

Traditional LCD display systems are well-known in the art—but are not known for being very energy efficient. A traditional display usually consists of a backlight, a bulk-diffuser, optional light shapers, a starting polarizer, a liquid crystal display (usually containing a liquid crystal layer followed by color filters), a finishing polarizer, and optionally a final diffusing layer that allows for wide angle viewing. LEDs are a common light used for high efficient displays, converting about 15% electrical power to light. The bulk-diffuser may be used to spread the light evenly from the backlight across the LCD, but can absorb as much as 60% (transmission of 40%) of the light. The light from the backlight is usually randomly polarized, and even if it isn't, the internal scattering of the bulk-diffuser may randomly polarize the light passing through it. The starting polarizer may allow only 40% of the light to pass through, the rest being absorbed. Adding a reflecting polarizer before the starting polarizer may improve this to about 50% by recycling incorrectly polarized light. The RGB color filters inside a “normal” LCD panel act as band-pass filters, where each of the color sub-pixels absorb the light in the other two bands, normally only 25% or less of the light is allowed through.

FIG. 1 depicts one embodiment of a conventional Liquid Crystal Display (LCD) display system 100. Light source 102 may be any one of any known white light source—e.g., LEDs, CCFL or the like. Light from source 102 may illuminate diffuser 104 to provide a more uniform illumination of backlight for the display. Light from diffuser 104 may illuminate a starting polarizer 106 that may, in turn, illuminate a LCD stack 108. LCD stack 108 may further comprise a liquid crystal 108a, which may modulate the amount of light transmitted through LCD stack 108 under control of a controller 112 that receives input image data.

The light passing through the liquid crystal 108a illuminates a color filter array 108b (e.g., red, green and blue filters) that serve to provide color rendering of the desired image. Finally, the light may pass through a finishing polarizer 110 to provide the final image.

As mentioned above, at each step in this display system, the amount of light is diminished accordingly. For example, a diffuser and/or a starting polarizer may have on the order of 40% transmissivity, respectively. The LCD stack with color filters may have on the order of 20% transmissivity. A finishing polarizer may have on the order of 80% transmissivity. As a result, the energy efficiency of a conventional LCD display system is not very high.

Apart from energy efficiency, one other desirable feature of newer, novel display systems is to provide High Dynamic Range (HDR). HDR displays are generally defined as having a dynamic range of greater than 800 to 1. Recent advances in technology have produced displays claiming contrast ratios of more than 1,000,000 to 1.

Generally speaking, these higher contrast ratio HDR displays utilize local dimming of the backlight that illuminates the LCD panel. An early patent in this area, U.S. Pat. No. 6,891,672, by Whitehead, Ward, Stuerzlinger, and Seetzen entitled “HIGH DYNAMIC RANGE DISPLAY DEVICES” describes the fundamental techniques. Such techniques include illuminating the LCD panel with an approximation of a desired image and then further modulating the approximation with the LCD panel so that it approaches the desired image.

Other forms of improving contrast have also been presented, including “darkening” of an LCoS projected image through the use of an LCD panel, and the use of multiple registered modulating layers or premodulators (e.g., Blackham U.S. Pat. No. 5,978,142, Gibbon U.S. Pat. No. 7,050,122, and others). However, commercially available HDR displays have deficiencies in reproducing starfields and other challenging images mainly due to parallax, backlight leakage, and other issues, and artifacts resulting therefrom.

### SUMMARY OF THE INVENTION

A display system comprising a set of light sources that emit a set of frequencies that are capable of exciting a set of quantum dots is disclosed. The display system further comprises a controller that receives input image data to be rendered by the display system and sends out control signals to various components. In one embodiment, the display system may further comprise one, two or more modulators that illuminate the set of quantum dots to form a final rendered image. In one embodiment, the set of light sources optionally comprise a light of substantially uniform polarization—e.g., laser light sources—and may be modulated according to control signal from said controller. Other optional components may comprise a starting polarizer, a mid-polarizer, a first laser light filter, a finishing polarizer and a final laser light filter/reflector.

In one embodiment, a display may comprise: a controller, the controller capable of receiving image data and sending out control signals; a set of light sources, said light sources capable of emitting light comprising a first set of frequencies; a starting polarizer, the starting polarizer receiving light from the set of light sources and transmitting light of a first polarization; a first modulator, the first modulator receiving light from the starting polarizer and modulating the light according to control signals received from the controller; a mid-polarizer, the mid-polarizer receiving light from the first modulator and transmitting light of a second polarization; a second modulator, the second modulator receiving light from the mid-polarizer and modulating the light according to control signals received from the controller; and a set of quantum dots, the set of quantum dots receiving light from the second modulator, wherein further the first set of frequencies are capable of exciting the set of quantum dots to emit light comprising a second set of frequencies.

In another embodiment, a display may comprise: a controller, the controller capable of receiving image data and sending out control signals; a set of light sources, said light sources capable of emitting light comprising a first set of frequencies, said set of light sources capable of modulating the light according to control signals received from the controller; a starting polarizer, the starting polarizer receiving light from the set of light sources and transmitting light of a first polarization; a first modulator, the first modulator receiving light from the starting polarizer and modulating the light according to control signals received from the controller; and a set of quantum dots, the set of quantum dots receiving light from the second modulator, wherein further the first set of frequencies are capable of exciting the set of quantum dots to emit light comprising a second set of frequencies.

In yet another embodiment, a display may comprise: a controller, the controller capable of receiving image data and sending out control signals; a set of light sources, said light sources capable of emitting light comprising a first set of frequencies, wherein further the light from the set of light sources comprise a substantially uniform first polarization; a first modulator, the first modulator capable of modulating the light according to control signals received from the controller; and a set of quantum dots, the set of quantum dots receiving the modulated light of the first set of frequencies, wherein further the first set of frequencies are capable of exciting the set of quantum dots to emit light comprising a second set of frequencies.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a conventional LCD display;

FIG. 2 is one embodiment of a display system as made in accordance with the principles of the present application;

FIGS. 3A and 3B are alternate embodiments of a laser diode backlight;

FIG. 4 is a cross section view of a Fresnel lens layer as made by used in many embodiments of the present application;

FIGS. 5A and 5B are a top view and a side view of a collimating lens arrangement as may be used in many embodiments of the present application.

FIGS. 6A and 6B each depict a side view and a top view of a suitable light source, without a collimating lens and with a collimating lens component, respectively.

FIGS. 7A and 7B depict a side view and a top view respectively of a light source having a beam spreading pattern as depicted.

FIG. 7C depicts one possible embodiment of a collimating lens sheet as may be employed with light source depicted in FIGS. 7A and 7B.

FIGS. 8A and 8B depict a side view and a top view respectively of a light source having a beam spreading pattern as depicted.

FIG. 8C depicts one possible embodiment of a collimating lens sheet as may be employed with light source depicted in FIGS. 8A and 8B.

FIG. 9 depicts one possible embodiment of an array of light sources and a possible collimating lens arrangement.

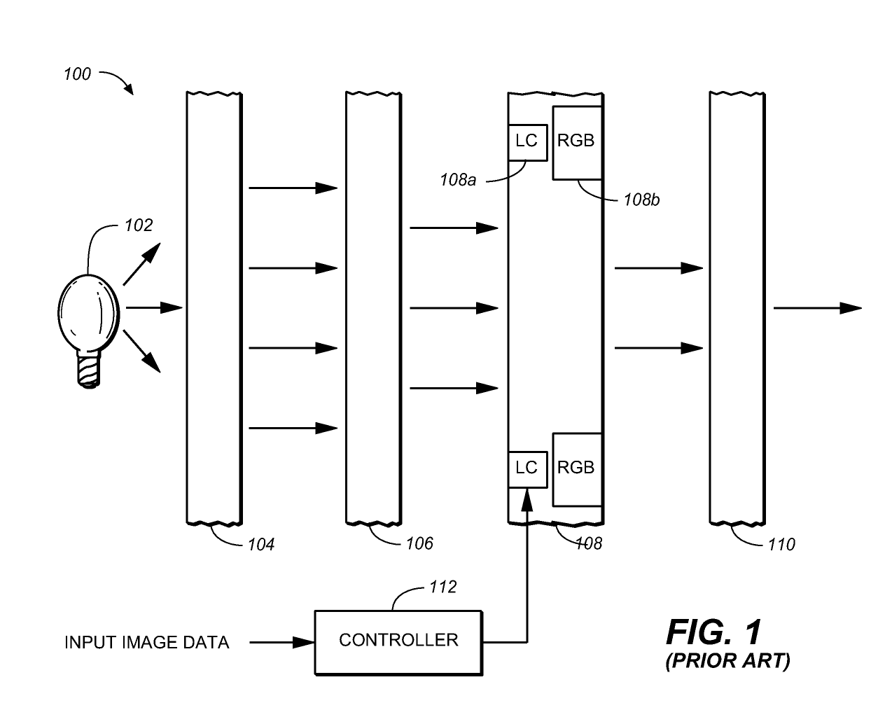

### DESCRIPTION OF THE PREFERRED EMBODIMENTS

### Introduction

Several novel HDR displays are described in co-owned patent applications:
(1) United States Patent Application 20110279749 to Erinjippurath et al., published on Nov. 17, 2011 and entitled “HIGH DYNAMIC RANGE DISPLAYS USING FILTERLESS LCD(S) FOR INCREASING CONTRAST AND RESOLUTION”;
(2) United States Patent Application 20120224121 to Gilbert, published on Sep. 6, 2012 and entitled “HIGH DYNAMIC RANGE DISPLAYS USING FILTERLESS LCD(S) FOR INCREASING CONTRAST AND RESOLUTION”;
(3) United States Patent Application 20130063496 to Basler et al., published on Mar. 14, 2013 and entitled “HIGH DYNAMIC RANGE DISPLAYS COMPRISING MEMS/IMOD COMPONENTS”;
(4) United States Patent Application 20130063573 to Erinjippurath, published on March 14, 2013 and entitled “HIGH DYNAMIC RANGE DISPLAYS HAVING IMPROVED FIELD SEQUENTIAL PROCESSING”; and
(5) United States Patent Application 20130106923 to Shields et al., published on May 2, 2013 and entitled “SYSTEMS AND METHODS FOR ACCURATELY REPRESENTING HIGH CONTRAST IMAGERY ON HIGH DYNAMIC RANGE DISPLAY SYSTEMS”

all of which are herein incorporated by reference in their entirety.

In many embodiments found in these references, light from a light source may be modulated by two modulators—e.g., a first modulator to provide a low resolution image of the desired image and a second modulator to provide the higher resolution image and desired color for a final image. In one embodiment, the first modulator may be a monochromatic LCD panel and the second modulator may be a color filtered LCD panel.

While these displays offer HDR image processing, the energy efficiency may still be improved upon.

### Overview

In many embodiments of the present application, display systems may use laser diodes (or other polarized-generated light source) to drive a liquid crystal display in a way that tends to avoid three of forms of efficiency losses found in current displays, as well as avoiding the “speckle” issue exhibited by other laser driven display designs, and parallax issues exhibited by other multi-layer or multi-modulated displays.

In many embodiments that use laser diodes, laser diodes tend to generate a linear polarized narrow (but not parallel) elliptical beam of monochromatic light. When used in laser pointers, they tend to be coupled with a lens that shapes the beam to be parallel (and circular). The common ones in use today may be modulated at around 50 Hz over roughly twice the brightness (not including off)—i.e. (0, 1-2). They also tend to be more efficient than LEDs and may convert power to light at 25% to 45% vs. 15% for LEDs.

In many embodiments, display system made in accordance of with the principles of the present application may comprise the following components in layers of:
(1) a 2D array of (optionally brightness modulated) monochromatic deep blue laser diodes, or other polarized light generator,
(2) an optional light shaping layer,
(3) an optional starting-polarizer,
(4) a first LCD panel without color filters (the field correcting LCD),
(5) a mid-polarizer,
(6) a second LCD panel without color filters (the image generating LCD),
(6) a finishing cellular polarizer layer,
(7) a cellular quantum dot layer finishing layer (the light converting layer),
And (8) a deep blue notch or low pass color filter layer (the anti-laser-filter) (optionally a cellular color band pass filter).

Other embodiments of display systems are described herein that may not use one or more of the above-mentioned components.

In one embodiment, the lasers may be arranged such that the light from each laser is polarized in a common direction with the starting polarizer, and spread across a known set of image elements in the field correcting LCD panel. An optional light-shaping layer preserves polarization while spreading the light from the lasers more evenly, or to increase collimation, or to direct light to a more precise set of image elements. The laser diodes can be modulated individually, or in small clusters, or in large zones depending on the desirability of small-scale contrast versus cost and complexity.

In general, there may be no need for a bulk diffuser (or light lost) between the light source and the LCD panel, and as the light that is created is already strongly linearly polarized, so there tends to be much less light lost at the starting polarizer (about 80% transmissive vs. 40%). If the quality of the polarization is not enough or greater contrast is desired, the optional starting polarizer may be added at a small brightness expense.

It will be appreciated that the order and orientation of the polarization layers in this display may vary—but it may be desirable that the laser polarization (from all the laser elements) matches the starting polarization layer, and the field correcting LCD finishing polarizer matches the starting polarization of the image generating LCD polarizer. This may be achieved by reversing the polarization films around one of the LCD panels.

The quantum dot array may form unique color sub-pixel elements (e.g., cells), a pixel being a grouping of cells that are used in concert to make a color over a small area. It will be appreciated that these arrays may form any known pattern—e.g. stripe, PenTile, quad structures or the like.

A first, field-correcting LCD panel may be a much higher resolution than the Laser diode array resolution, as its function is both to provide the more local brightness modulation, as well as make the brightness more uniform across the image generating LCD layer—e.g., to provide a local brightness modulation layer.

A second, image-generating LCD resolution may be matched to the field correcting LCD at a 1:1 cell, 1:1 pixel, or many to one pixels depending on size and desired control. It should be noted that the finishing polarizer may be placed before the quantum dot layer, as the amount of monochromatic light may be dually modulated before it is converted by the quantum dots to the final observed light.

A final polarizer may be cellular matching the resolution of the LCD, so that light may not scatter into adjacent cells. An optional quarter wave polarizing layer may be added here to prevent light being emitted from the front from getting back into the LCD layer.

The quantum dot finishing layer may be arranged in cells of unique color composition (much like the color filters are in a traditional display”), usually at red, green, blue values (or any other suitable colors that may be a metamer of white) that define the desired gamut. There may be light barriers between each cell so that light driving one element may not scatter to adjacent cells.

In another embodiment, it may be possible to use matching color filter films in front of each color cell to prevent ambient light from exciting the quantum dots. In yet another embodiment, it may be possible to use a band pass (e.g., around the laser wavelength) interference film behind the quantum dot layer to possibly doubling the light directed out of the display. A notch filter interference film in front of the quantum dot layer may reflect unprocessed laser light back into the display may also be used to improve efficiency. A final color filter may also be a lower cost single layer low pass below the laser wavelength, so that no direct laser light makes it out of the front of the display.

In many embodiments and unlike other laser driven displays, it may be desired that no laser light makes it out of the display—e.g., all light leaving the display is substantially converted to randomly polarized, wide diffusion angle light by the quantum dots. This should tend to eliminate the speckle effect that directly viewed monochromatic laser light usually creates.

In viewing the power to light efficiency of these display systems, the overall power to light efficiency of a display may be calculated by multiplying the transmission of the layers together.

In a conventional LCD display, it may be the case of:

0.15(LED eff.)*0.4 (bulk diff.)*0.5 (starting polarization)*0.25 (color filters)=0.0075

In many present embodiments, if the quantum dot efficiency is assumed as 80% (i.e. eighty percent of the light hitting the QD layer is converted to light of the appropriate color, and factor an additional LCD and polarizer layer with 70% transmission), then then efficiency would be calculated as such:

0.45 (Laser diode eff.)*0.8 (starting polarization)*0.7 (2nd LCD)*0.8(quantum dot eff.)=0.2016—or roughly 25 times more efficient than “normal” display.

This maybe improved further by using zonal laser brightness modulation. Other alternative embodiments may have greater efficiencies.

### Several Embodiments

Many embodiment described herein affect ways to construct a display that is at least an order of magnitude more efficient than conventional displays, as well as hitting HDR/VDR limits in color, brightness and contrast. In many of the present embodiments, most of the components that comprise these new display configuration are available today.

In several embodiments, display system are described that may affect a range of features (or subsets thereof)—such as power efficient, high brightness, High Dynamic Range, wide color gamut performance. In many of these embodiments, these display systems may comprise one or more of the following components: laser diode backlights or edge lights, one or more color-filter-free liquid crystal panels, and quantum dot photoluminescence films.

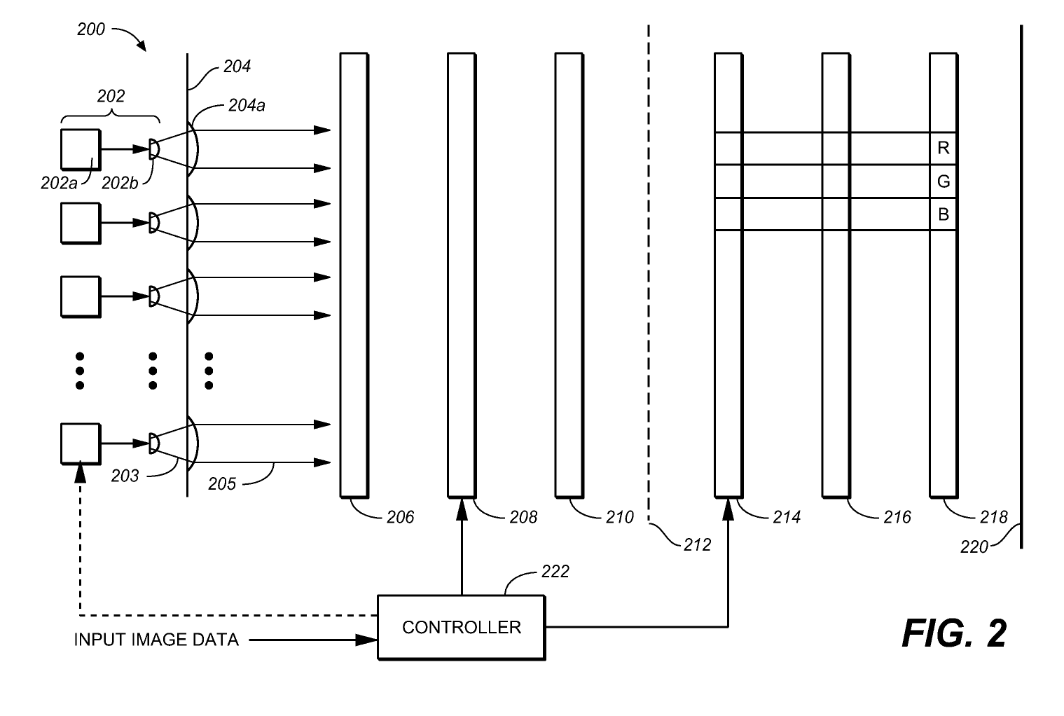

FIG. 2 depicts one embodiment of a display system 200 as made in accordance with the principles of the present application. Display system 200 may comprise an array of laser diodes 202—which may, in turn, comprise a laser diode 202a, with or without an optional lens 202b to help to disperse the light from the laser diode. The light from laser diode 202 may illuminate a Fresnel lens sheet 204 where individual Fresnel lenses 204a may serve to provide substantial collimation of the laser light.

In one embodiment, laser diodes may be in the blue to ultraviolet range (e.g., around 400 nm or the like)—however, the laser diodes may be any color possible that may excite a set of quantum dots to produce a set of colors that may be substantially a metamer of white light, as will be discussed later. The use of quantum dots for displays are described in co-owned patent applications:
(1) United States Patent Application 20120154417 to Ninan et al., published on Jun. 21, 2012 and entitled “TECHNIQUES FOR QUANTUM DOT ILLUMINATION”; and
(2) United States Patent Application 20120155060 to Ninan, published on Jun. 21, 2012 and entitled “QUANTUM DOT MODULATION FOR DISPLAYS”.

all of which are hereby incorporated by reference in their entirety.

In another embodiment, light sources 202 may comprise super-luminescent diodes—or any other known (or unknown) sources of preferably a polarization controlled light source, and possibly a source that may be variable. In yet another embodiment, the light sources may be any light source that emits a set of frequencies that may excite a set of quantum dots—whether having substantially a uniform polarization (e.g. laser diodes, super-luminescent diodes) or not (e.g. LEDs or the like). If the light source does not have substantially a uniform polarization, then the starting polarizer may impose one—but this may be affected at the cost of energy efficiency.

If the light sources have a substantially a uniform polarization that matches the starting polarizer, then the resulting display system may achieve better energy efficiency. The first or starting polarizer may be optional. In addition, the first polarizer may be a separate component in the optical stack—or may be a layer added to the first modulator.

In many embodiments, it may be desirable to have the light coming from the laser diodes to be dispersed substantially so that the backlight is flattened, so that no or few “hot spots” are discernible by a viewer of the display system. In addition, it may be desirable to have the light coming from the laser diodes to be relatively collimated to provide a uniform illumination to optical components downstream.

It may also be desirable to select lens and/or lens sheets to be of polarizing preserving materials (e.g., certain plastics, glass or the like). As light from the laser diodes is substantially polarized, it may be desirable to have this initial polarization match up with a starting (or first) polarizer 206.

If this is the case, then the transmissivity from the starting polarizer may be 80-90%—which is an improvement over the case with a conventional display system.

Light from the starting polarizer 206 may illuminate a first modulator 208 (e.g., a monochrome LCD) that may provide a low resolution illumination based on the desired image to be rendered. This first modulator may substantially modulate the brightness for the desired image. Mid-polarizer 210 is employed to provide a proper orientation prior to illuminating a second modulator.

Optional laser light filter 212 may be employed to provide a laser pass filter so that laser light reflecting back from later optical stages may not adversely affect the contrast of the display system.

For another embodiment, component 212 may be an optional mid holographic diffuser. Holographic diffuser 212 may be employed to spread light from Liquid Crystal (LC) 208 image elements over a greater area over the LC 214 image elements, e.g., in an angle controlled and polarization preserving way. This may tend to remove Moire effects between the two LC panels. In addition, as the image is realized completely in the Quantum Dot (QD) layer 218 (as discussed below) which is substantially viewer-invariant (e.g., being a surface conversion), the diffusion strength may tend to be much less than other dual modulation style displays.

If the pixel feature size is large compared to the display stack depth, then this diffuser may not be desired. Not having this diffuser (and compensating for the relative pixel brightness variations at LC 214) may affect a display of less layers, less cost, and greater efficiency. In yet another embodiment, component 212 may be a combined optional laser light filter and a holographic diffuser.

It should be appreciated that, although the display as shown in FIG. 2 has a particular order of components—e.g., laser light filter and/or holographic diffuser between the mid-polarizer and a second modulator, it may be possible to affect a display having component in a different order—e.g., laser light filter and/or holographic diffuser between the first modulator and the mid-polarizer—or other components in a different order.

Light may then illuminate a second modulator 214 (e.g. a monochrome LCD) that may provide modulation to render higher spatial frequency data for rendering the desired image. A finishing polarizer 216 may be provided thereafter.

Quantum dot array 218 is provided such that, when laser light of a suitable frequency illuminates a quantum dot, the quantum dot is excited to re-emit light of another frequency. In one embodiments, an array of quantum dots (e.g. 1080×720 dots, or any other dimensions) may be placed across a display screen to provide to provide full-color (e.g., with red, green and blue emitting dots) image rendering.

It may be desirable that the second modulator 214, the finishing polarizer 216 and the quantum dot array 218 be carefully constructed (e.g., within suitable tolerances) so that light may efficiently be produced to form the final image.

An optional low pass filter/reflector 220 may be placed at the end to either absorb and/or reflect the laser light. This may be desirable for two reasons: (1) to avoid any speckles of laser light from being noticed by the viewers of the display systems and (2) to reflect laser light back into the quantum dot array to produce desired colored light, thereby boosting energy efficiency.

Controller 222 may be employed to receive input image data to be rendered by the display system. Image processing algorithms may produce control signals that may be applied to the first modulator, second modulator and/or the array of laser diodes. In one embodiment, the laser diodes are kept ON and not substantially modulated by the controller. In this case, the controller may control the first modulator and the second modulator. In another embodiment, all three components (e.g., laser diodes, first modulator and second modulator) may be controlled by the controller. In yet another embodiment, a display system may be constructed where only the laser diodes are controlled by the controller and further that the display system only has one modulator (as opposed to two modulators).

In another embodiment, a display system may comprise a set of light sources where the light sources emit a frequency or a set of frequencies that excite a set of quantum dots downstream in the optical path. The light sources may be optionally modulated by the controller and may be of a substantially uniform polarization. In that case, the starting polarizer may be optional. The display system may further comprise either one, two or multiple modulators downstream in the optical path. If there is only one modulator, then the modulated light from the light sources may comprise a low resolution image according to control signals received from the controller and the image from the single modulator may comprise a high resolution image according to control signals received from the controller.

### Backlight Embodiments

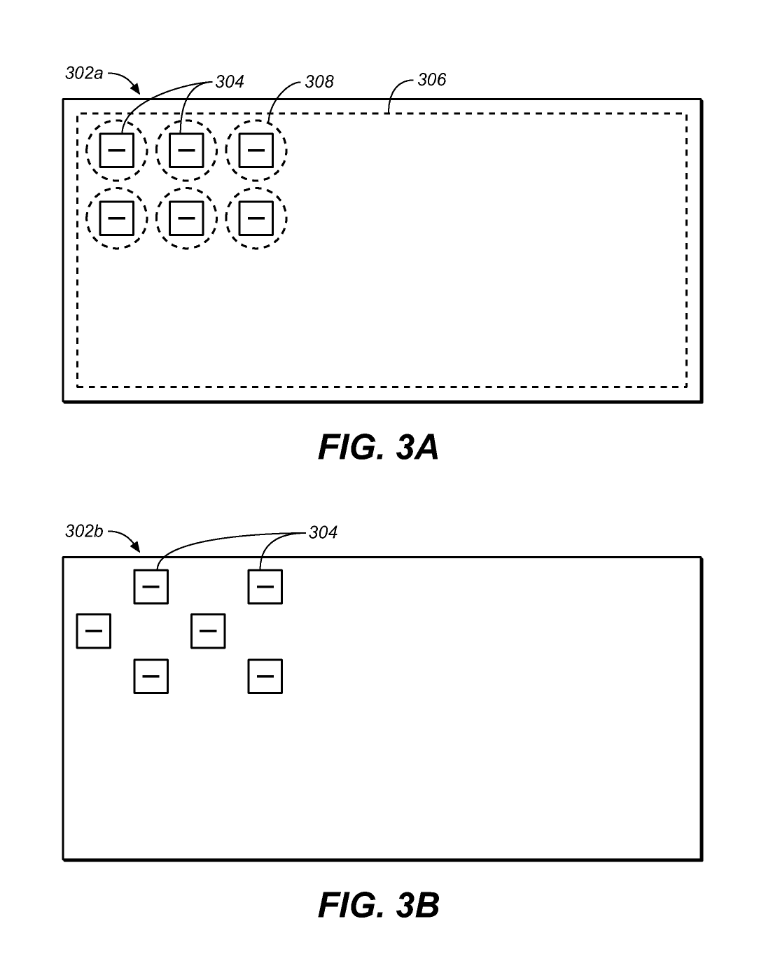

FIGS. 3A and 3B depict two possible embodiments of a laser diode backlight 302a and 302b respectively. In FIG. 3A, backlight 302a may comprise a substantially rectangular array of laser diodes 304—and placed in such sufficient density so that a uniform illumination may be provided for downstream optical components. In this embodiment, a Fresnel lens sheet 306 may be placed over the laser diodes such that Fresnel lenses 308 may provide any desired collimation of the light. FIG. 3B depicts another embodiment of a laser diode backlight 302b wherein the laser diodes are placed on a triad pattern. It will be appreciated that any other pattern may suffice for purposes of the present application.

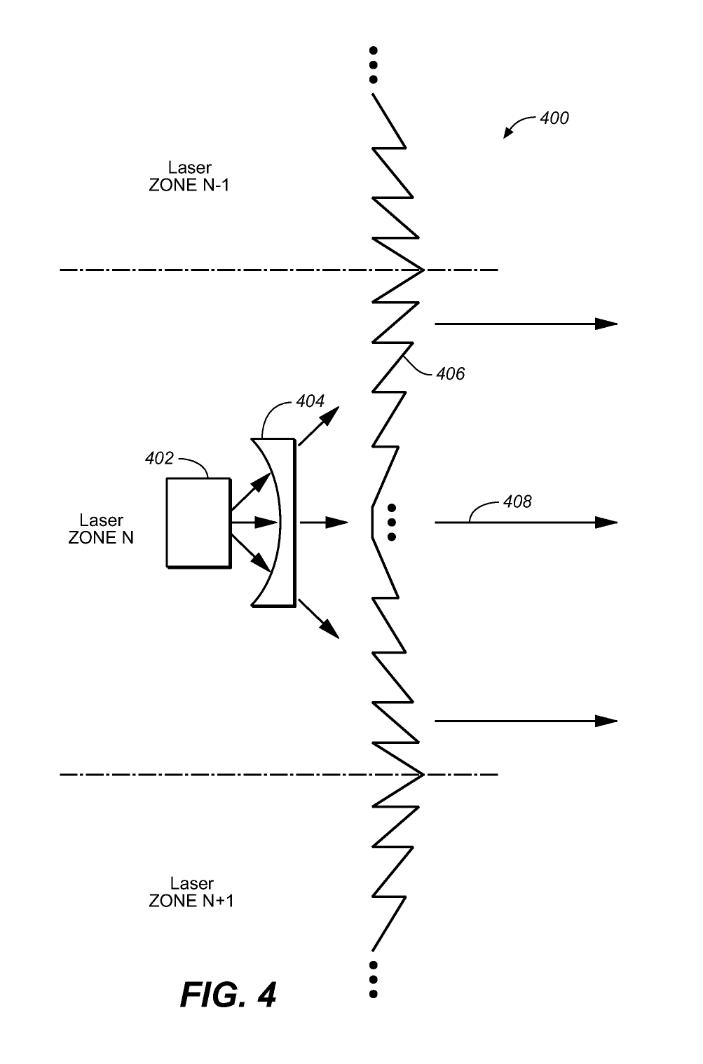

FIG. 4 depicts one embodiment of a backlight structure in which the Fresnel lenses may affect different laser zones (e.g., N−1, N, N+1, as shown). Laser diode 402 may emit laser light—and depending on whether any further dispersion is desired for the light, an optional negative lens 404 may be employed.

Dispersed light may illuminate the Fresnel lens 406—and due to desired variations in slope across the lens—may serve to help collimate the light 408 for downstream optical components.

### Collimating Embodiments

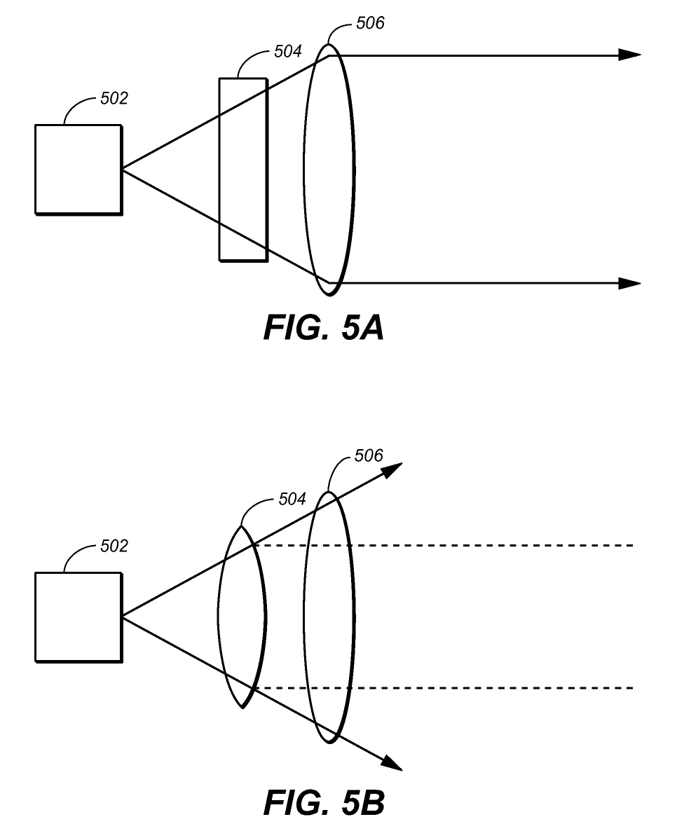

FIGS. 5A and 5B represent a top view and a side view, respectively, of a lens arrangement that may be used to help collimate the laser light. As seen, laser diode 502 may emit laser light to a positive cylindrical lens 504 and, thereafter, to a spherical lens 506. This lens arrangement may be used in lieu of, or in conjunction with, any Fresnel lens arrangement previously mentioned.

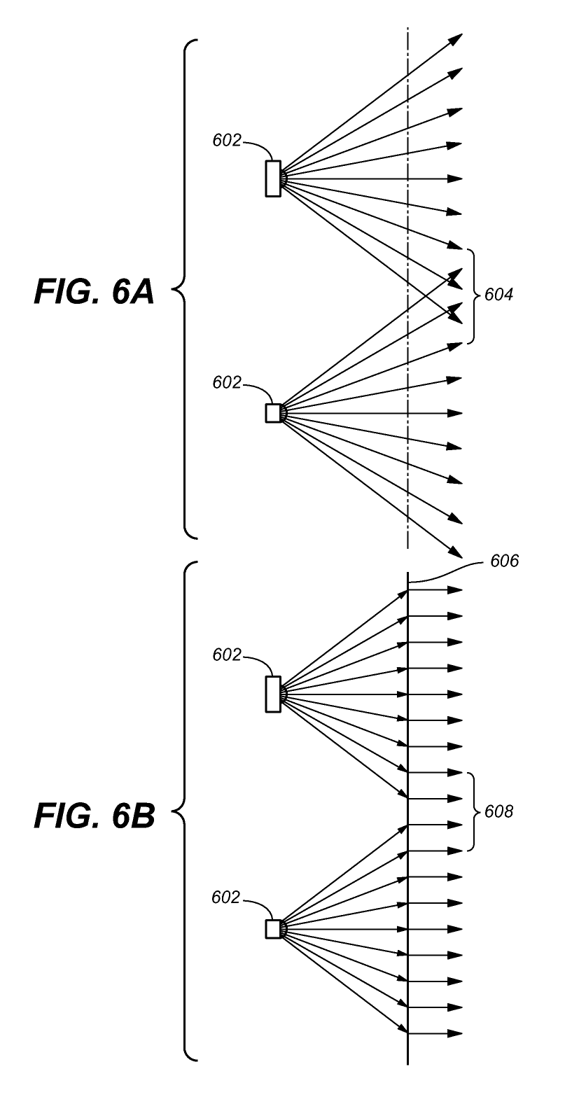

In continued reference to FIG. 4, FIGS. 6A and 6B each depict a side view and top view respectively of the light pattern where there is not Fresnel lens sheet and where there is a Fresnel lens sheet 606. In FIG. 6A, it may be seen that light source 602 affect a substantially diverging beam of light (as depicted by beams 604)—in both the side and top views. In FIG. 6B, it may be seen that Fresnel lens sheet 606 provides a substantially collimated beam (as depicted by beams 608)—in both the side and top views.

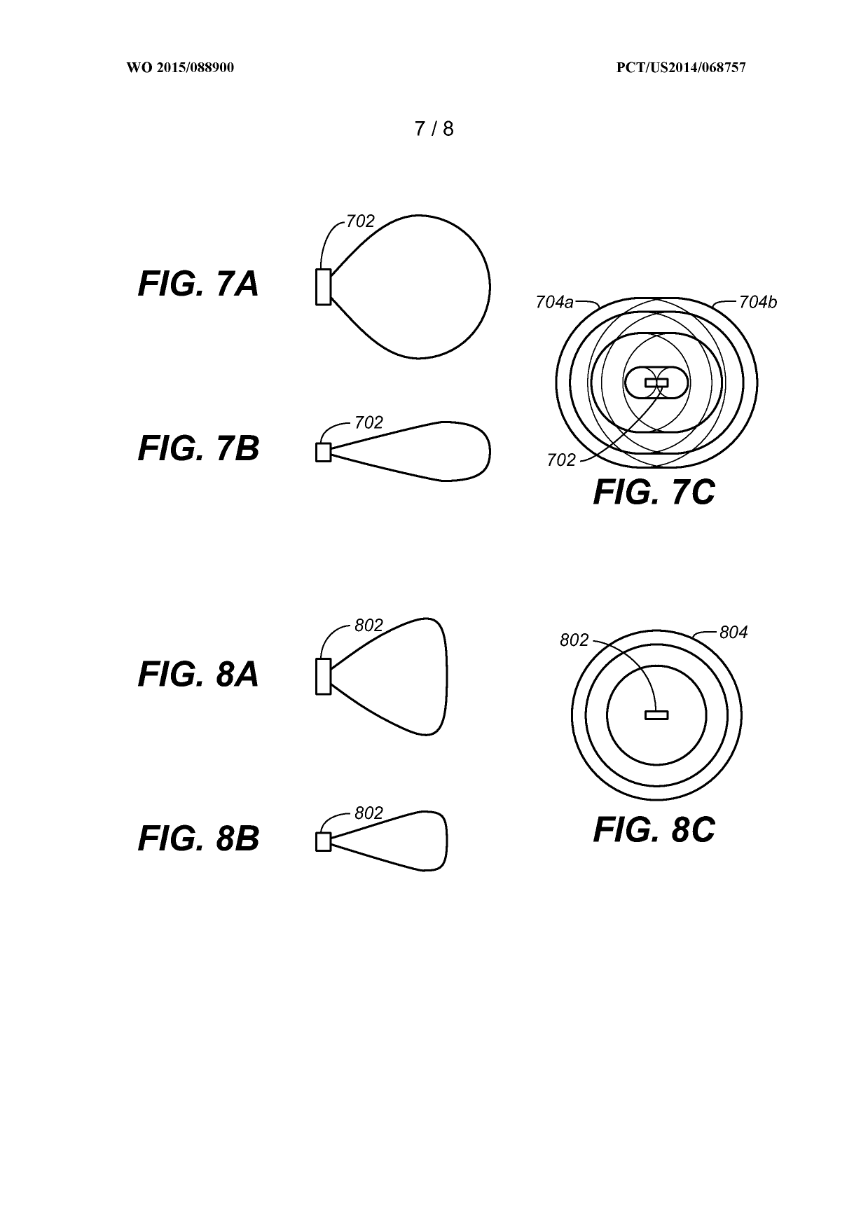

FIGS. 7A and 7B depict the beam patterns of one particular light source 702 in the side view and top view, respectively. In FIG. 7C, it may be desirable to employ a set of overlapping Fresnel lens arrangements (704a and 704b) in order to affect a more uniform illumination in both the top and side directions.

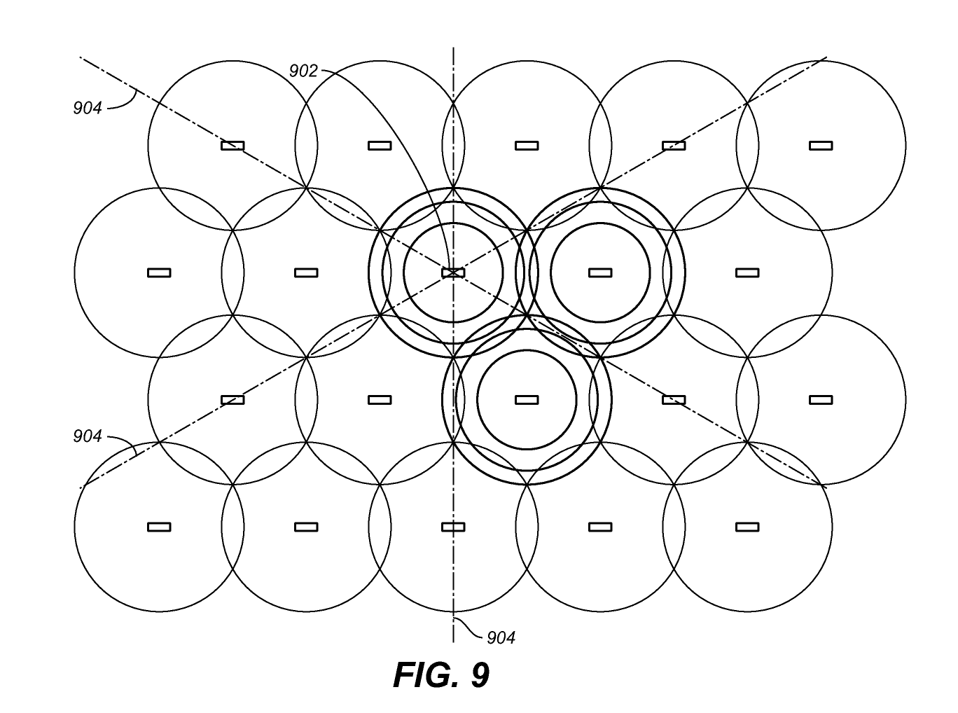

FIGS. 8A and 8B depict the beam patterns of another light source 802 in the side view and top view, respectively. In FIG. 8C, it may be desirable to employ a substantially more concentric set of Fresnel lens arrangement (804) to achieve a desired uniform illumination.

FIG. 9 depicts one embodiment of an array of light sources 902 that may be placed on a grid arrangement 904, as depicted. As may be seen, a Fresnel lens sheet may affect a set of intersecting concentric circles (as depicted on source 902). It will be appreciated that the sources may be placed on different patterns—which may affect a different set of Fresnel lenses upon a sheet.

### Contrast

Conventional displays without dynamic backlighting are 600:1 to 1000:1 depending on panel construction. Usually the more contrast, the less efficient.

Assuming a non-modulated laser backlight and no starting polarizer, have 100:1 per pixel cluster (3 to 5 pixels diameter) brightness control multiplied with a 1000:1 per sub-pixel image element control, several embodiments herein may get a 50k:1 measured contrast.

By adding a starting polarizer, this may increase this by a factor of 10. It should be noted that this is per-pixel cluster, which at reasonable viewing distances may be far below the eye's normal light halo diameter.

### Viewing Angle

Light from display comes from the front quantum dot layer only and is independent of the display element geometry behind this layer.

### Brightness

Peak brightness tends to be limited only by the quantum dot photoluminescence saturation limit, and its transmission through the anti-laser-light filter.

### Color Gamut

The color gamut in a conventional display is determined by the backlight spectrum, the per-cell contrast, and the color filters in the LCD panel. This is usually inversely related to efficiency, as a larger color gamut requires smaller band pass filters and therefore less light. In many embodiments herein, large color gamuts may be reachable by modulating the backlight color spectrum (e.g., backlight color mixing), and particularly for features with large screen areas. These display systems' color gamut may be determined by the per-cell contrast, and the selection of quantum dots (which are created to have a very narrow spectrum per color). This may allow for very large-color gamuts on a per-pixel basis.

To further appreciate the wide color gamut aspects of these novel display systems, a conventional LCD display typically has per-pixel control of three color filters (typically Red, Green and Blue), each opens or closes a fairly broad color filter from a broad spectrum white source. By contrast, these new display systems provide much greater control over how much light may be emitted from a given area of the screen—in addition, to how much light may be converted into very narrow band primaries. This allows these new displays to hit colors not available on normal displays due to the extended color space (e.g., compare Adobe Wide-Gamut RGB Color space with Rec. 709 for example), and/or due to the extended dynamic range (for example a dark saturated blue falling well below the black level of a normal display).

### Possible Improvements

The following are possible embodiments having potential improvements.

Dual-population modulation, or error diffused modulation zones

Typically, a laser may be off, on at minimum, or on up to full brightness. On at minimum is relatively bright compared to off. Turning on a full zone from off might be too much of a change from all off.

In one embodiment, by turning off half of the lasers in a checkerboard pattern, with a field flattened by the brightness LCD, may allow for half minimum normal brightness levels that may be controlled upwards by bringing up the brightness of the “on” half of the lasers before turning on the full zone as needed. Depending on the per-laser light spread other patterns could be used.

Dual-population modulation zones by light source.

In this embodiment, it may be possible to mix laser diodes and pulse width modulated LEDs in a manner that may allow for continuous brightness control all the way from fully lit to fully off.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. Furthermore, the inventors recognize that newly developed technologies not now known may also be substituted for the described parts and still not depart from the scope of the present invention. All other described items, including, but not limited to panels, LCDs, polarizers, controllable panels, displays, filters, glasses, software, and/or algorithms, etc. should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention may also include a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, HD-DVD, Blue-ray, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, calculating pixel/sub-pixel blurring of a local dimming panel, calculating color correction or characterizations, preparing image signals and applying them to driver and/or other electronics to energize backlights, panels, or other devices in a display, calculating luminance values, interpolating, averaging, or adjusting luminance based on any of the factors described herein, including a desired luminance for a pixel or region of an image to be displayed, and the display, storage, or communication of results according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

1. A display comprising:
a controller, the controller capable of receiving image data and sending out control signals;
a set of light sources, said light sources capable of emitting light comprising a first set of frequencies;
a starting polarizer, the starting polarizer receiving light from the set of light sources and transmitting light of a first polarization;
a first modulator, the first modulator receiving light from the starting polarizer and modulating the light according to control signals received from the controller;
a mid-polarizer, the mid-polarizer receiving light from the first modulator and transmitting light of a second polarization;
a second modulator, the second modulator receiving light from the mid-polarizer and modulating the light according to control signals received from the controller; and
a set of quantum dots, the set of quantum dots receiving light from the second modulator, wherein further the first set of frequencies are capable of exciting the set of quantum dots to emit light comprising a second set of frequencies.

2. The display of claim 1 wherein the set of light sources further comprise a set of light sources that emit light that comprises substantially the first polarization.

3. The display of claim 1 wherein the set of light sources comprises one of a group, said group comprising: laser diodes, LEDs and super-luminescent diodes.

4. The display of claim 2 wherein the display further comprises one of a group, said group comprising: a laser light filter and a holographic diffuser.

5. The display of claim 4 wherein the laser light filter or the holographic diffuser is disposed between the mid-polarizer and the second modulator.

6. The display of claim 1 wherein the display further comprises a finishing polarizer, the finishing polarizer being disposed between the second modulator and the set of quantum dots.

7. The display of claim 1 wherein the set of quantum dots are arranged in pattern across a display screen and further wherein, the second set of frequencies are a metamer of white.

8. The display of claim 1 wherein the display further comprises a low pass filter/reflector, the low pass filter/reflector disposed after the set of quantum dots and capable of absorbing or reflecting light of the first set of frequencies back towards the set of quantum dots.

9. The display of claim 1 wherein the display further comprises a set of collimating elements, the collimating elements capable of substantially collimating the light emitted by the set of light sources.

10. The display of claim 9 wherein the collimating elements comprises one of a group, said group comprising: a set of collimating lenses and a Fresnel lens sheet.

11. The display of claim 1 wherein the first modulator is capable of forming a low resolution image, according to the control signals received from the controller.

12. The display of claim 11 wherein the second modulator is capable of forming a high resolution image, according to the control signals received from the controller.

13. The display of claim 12 wherein the first modulator and the second modulator comprise monochromatic LCDs.

14. The display of claim 1 wherein the set of light sources are capable of modulating the light according to control signals received from the controller.

15. A display comprising:
a controller, the controller capable of receiving image data and sending out control signals;
a set of light sources, said light sources capable of emitting light comprising a first set of frequencies, said set of light sources capable of modulating the light according to control signals received from the controller;
a starting polarizer, the starting polarizer receiving light from the set of light sources and transmitting light of a first polarization;
a first modulator, the first modulator receiving light from the starting polarizer and modulating the light according to control signals received from the controller; and
a set of quantum dots, the set of quantum dots receiving light from the second modulator, wherein further the first set of frequencies are capable of exciting the set of quantum dots to emit light comprising a second set of frequencies.

16. The display of claim 15 wherein the set of light sources are capable of forming a low resolution image, according to the control signals received from the controller.

17. The display of claim 16 wherein the first modulator is capable of forming a high resolution image, according to the control signals received from the controller.

18. A display comprising:
a controller, the controller capable of receiving image data and sending out control signals;
a set of light sources, said light sources capable of emitting light comprising a first set of frequencies, wherein further the light from the set of light sources comprise a substantially uniform first polarization;
a first modulator, the first modulator capable of modulating the light according to control signals received from the controller; and
a set of quantum dots, the set of quantum dots receiving the modulated light of the first set of frequencies, wherein further the first set of frequencies are capable of exciting the set of quantum dots to emit light comprising a second set of frequencies.

19. The display of claim 18 wherein the set of light sources capable of modulating the light according to control signals received from the controller.

20. The display of claim 18 wherein the display further comprises a starting polarizer, the starting polarizer receiving light from the set of light sources and transmitting light of a first polarization to the first modulator.

21. The display of claim 20 wherein the display further comprises:
a mid-polarizer, the mid-polarizer receiving light from the first modulator and transmitting light of a second polarization; and
a second modulator, the second modulator receiving light from the mid-polarizer and modulating the light according to control signals received from the controller.
